(19) United States
(12) Patent Application Publication
(10) Pub. No.: US 2015/0138320 A1
(43) Pub. Date: May 21, 2015

(54) High Accuracy Automated 3D Scanner With Efficient Scanning Pattern

(71) Applicant: Antoine El Daher, Kenmore, WA (US)

(72) Inventor: Antoine El Daher, Kenmore, WA (US)

(21) Appl. No.: 14/085,805

(22) Filed: Nov. 21, 2013

(51) Int. Cl. H04N 13/02

(52) U.S. Cl. CPC H04N 13/0253; H04N 13/0221
USPC 348/46

(57) ABSTRACT

A high accuracy automated 3D scanner having one or more movable components, capable of correctly scanning objects made of one or more different materials, as well as objects with complex or simple geometry. In its main embodiment, the scanner operates by positioning its internal components in certain positions, capturing geometric data, then evaluating that geometric data to find the optimal next position to which it should move its components. This process can thus be repeated several times resulting in increasingly accurate scans. It is also capable of using a combination of multiple lights to get properties of the materials being used and refine the scan appropriately. The system as a whole is economical and requires nearly no user intervention.

### BACKGROUND

### Prior Art

The following is a tabulation of some prior art that presently appears relevant to this application:

U.S. Patents

| Patent Number | Kind Code | Issue Date | First Patentee |
|---|---|---|---|
| 3,625,618 | A | 1971 Dec. 7 | Bickel |
| 4,089,608 | A | 1978 May 16 | Hoadley |
| 5,027,281 | A | 1991 Jun. 25 | Rekow |
| 5,477,371 | A | 1995 Dec. 19 | Shafir |
| 5,636,030 | A | 1997 Jun. 3 | Limbach |
| 5,747,822 | A | 1998 May 5 | Sinclair |
| 5,894,529 | A | 1999 Apr. 13 | Ting |
| 6,549,288 | B1 | 2003 Apr. 15 | Migdal |
| 6,633,416 | B1 | 2003 Oct. 14 | Benson |
| 6,917,702 | B2 | 2005 Jul. 12 | Beardsley |
| 7,106,898 | B2 | 2006 Sep. 12 | Bouquet |
| 7,995,834 | B1 | 2011 Aug. 9 | Knighton |
| 8,126,261 | B2 | 2012 Feb. 28 | Medioni |
| 8,326,025 | B2 | 2012 Dec. 4 | Boughorbel |
| 8,493,496 | B2 | 2013 Jul. 23 | Freedman |

A 3D scanner is an apparatus that captures the geometry of real physical objects, and converts them into an accurate digital representation.

Although 3D Scanners have been around for several years, most of them have been unable to provide high accuracy models while maintaining low production cost and a fast scanning speed. This can be evidenced by looking at today's 3D Scanner market, where most high-accuracy scanners cost in the thousands of dollars, and most low-cost scanners generate low-accuracy models. In this application, we will use the term high-accuracy to mean any model where the scanned object representation is within a 1 mm error or less of the physical model.

In particular, some 3D scanners, known as 3D laser scanners, use lasers or other high-intensity light emitters to project a light beam onto an object, and then have a camera or other sensor pick up the projected laser profile, using it to mathematically reconstruct the geometry of the object. Those scanners tend to suffer from being slow and expensive, but are usually very accurate. One of the earliest mentions of such a system dates back to 1969, in Bickel's U.S. Pat. No. 3,625,618. It describes the general method of shining a narrow beam of laser and capturing geometry from it—as we will see later, one of the issues with this patent and the next few patents is that they are not very good at dealing with occlusions and at processing data quickly. A few years later (1976), U.S. Pat. No. 4,089,608 took the idea further and made it more explicit. Further refinements have followed in the eighties and nineties, including U.S. Pat. Nos. 5,027,081, 5,477,371 and 5,636,030, which essentially introduce the turntable system and movable carriages. Later patents such as U.S. Pat. No. 6,917,702 introduce methods to use and calibrate multiple fixed cameras with the turntable but adding more cameras adds more cost and doesn't guarantee a much better model. Most of these scanners only capture geometry and fail to capture color and texture. Many 3D laser scanners also suffer from occlusion problems—for example, any time a camera and a laser are in a fixed position several details of the objects will not be visible. For example, when scanning a teapot with a fixed position laser scanner, it is difficult to capture the inside of the handle as it is occluded by the main body of the teapot on one side and the outside of the handle on the other. Practically, 3D scanners that are based on fixed position light emitters don't perform very well when given non-convex objects. They can mitigate this by making the camera/lasers moveable but that often entails significantly longer scan times.

There have also been successful attempts to improve this by increasing the number of lasers, as suggested by Knighton in U.S. Pat. No. 7,995,834. However, the common theme is that there is usually a trade-off between cost, speed and accuracy. In this case the cost is higher since several lasers have to be involved as those tend to be the most expensive part of a scanner in high-accuracy scanners.

Other scanners use a technique known as structured lighting to quickly get a 3D view of the image. Recently those scanners have become less expensive but currently still suffer from relatively low accuracy. Those have become more main stream recently with patents such as U.S. Pat. Nos. 6,549,288 and 8,493,496. The idea is to project patterns and then capture them. The main disadvantage there is that the projection used becomes very expensive if higher accuracy is required and they currently are only able to deterministically capture only the part of the model that is visible. A simple way to get an estimate is to compare the price of a laser pointer to that of a full high resolution digital video projector.

There are many other methods of 3D scanning available out there, ranging from taking pictures at multiple focal lengths to just using a bed of pins and placing the object on it in U.S. Pat. No. 6,633,416, then measuring the pin displacement. The latter is a contact-based 3D scanner so it differs substantially from ours—it also fails to capture any angled holes or features since the object is placed flat against the pins. Some scanners will just look at the shadows cast by the object from various angles and try to reconstruct it as is the case in U.S. Pat. No. 7,106,898.

Some 3D scanners don't use active illumination (i.e. no structured light, no laser) and just passively take pictures of the target object and then attempt to recombine. This is for example the case with U.S. Pat. No. 5,894,529 where several precisely positioned cameras take pictures. The problem with such scanners is that the reconstructed geometry is overall sparse and inaccurate as the device attempts to recreate a full 3D model out of just a handful of pictures, and they are very susceptible to shadows or other lighting variations. Other methods attempt to match the images to one another and generate a model by identifying distinguishable features. The issue here is that objects which are fairly uniform in color sometimes don't have many distinguishable features. For example, scanning a completely blue ball would be unsuccessful as those devices are unable to match the various pictures of the ball since there are really no distinguishing features. Also, the required processing time for generating such images is significant.

In addition to the aforementioned issues with each of these non-contact scanners, all of these embodiments suffer from some common problems: first, many of them react differently based on the target object's material. For example, if a laser is being shined against a white glossy surface, its reflection will be much more pronounced than if it's being shined against a black matte surface, leading to significant errors. Second, most of them try to find a balance between accuracy, speed and cost but none of them manage to get good results on all three at once. Third, a lot of these have a significant amount of wasted scan time, meaning that they spend a lot of time scanning parts that have already been scanned and don't need to be again. This is more common for laser scanners where often a full scan will be made with a laser, then the camera/laser will be repositioned and another full scan will be made to get more details. This often takes the scan time up to dozens of minutes and sometimes even hours. As we will be dealing with this concept again, we can define wasted scan time as time spent scanning an area of the physical model that our system already has confidently and correctly digitized. Fourth, many scanners have problems in dealing with occlusions and complex models are usually only partially scanned—this is because for scanners with movable cameras/light emitters, there can be an infinite number of positions that can be used and it's impractical and sometimes impossible to scan them all.

In this application, we propose a design and methods for an apparatus capable of combining high accuracy and low-cost, while being resilient to the problems described above.

### SUMMARY

One embodiment for solving this problem follows: we propose a device comprising an automatically movable light emitter, an automatically movable white light, an automatically movable light receptor, a turntable with positional feedback, an enclosure, and a way to efficiently process the information and select where to scan next. In this embodiment, the device starts by rotating the object on the turntable while shining the light emitter onto it and capturing the profile with the receptor in a manner similar to most turntable scanners. The processor uses this to reconstruct a first pass of the geometry. In a second step, the object is illuminated with white light, and the model's colors are captured. In a third step, the colors are used to refine the originally acquired geometry. For example, if a spot on the model is white, or the same color as the light emitter, the threshold for considering the reflection to be a point is increased, whereas if a laser point had been captured on a black colored point then odds are it is a real physical point. In a fourth step, the processor uses the captured geometry to find areas that haven't been captured (for example, places that appear as holes or that have very low point density) and moves the lasers and cameras to a position and angle that is optimal for capturing those missing parts. The processor may also choose to get closer scans from areas that are blurry or noisy as this indicates there is more detail than the scanner captured. This repeats until all the missing parts have been successfully captured or the desired time limit has elapsed.

The end result is that the object captured will have all the required detail and will not be masked by significant occlusions, while minimizing wasted scan time.

We describe several other embodiments in the detailed description and claims.

### ADVANTAGES

We propose a design for a 3D laser scanner that is highly accurate, low cost, high speed, and can deal with several kinds of materials that are otherwise troublesome for 3D scanners, as well as models that contain significant occlusions and holes.

### DRAWINGS

FIG. 1 shows a perspective view of the first embodiment.

FIG. 2 shows a second perspective view of our first embodiment from an angle different than that of FIG. 1, so as to reveal some of the inner parts.

FIG. 3 shows a second proposed embodiment.

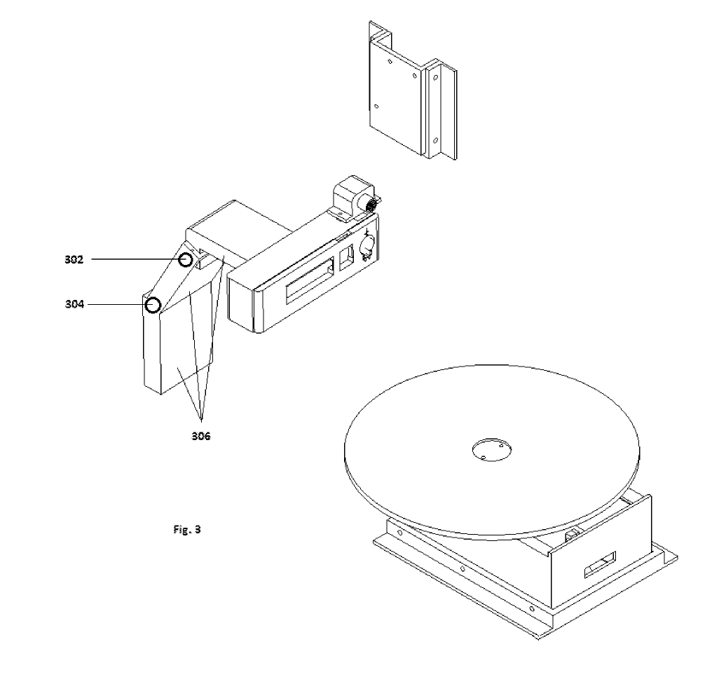

FIG. 4 shows a flowchart explaining the main steps taken by the first embodiment.

FIG. 5 shows a third proposed embodiment.

FIG. 6 shows a possible enclosure that can be used with the apparatus.

### DETAILED DESCRIPTION

### First Embodiment

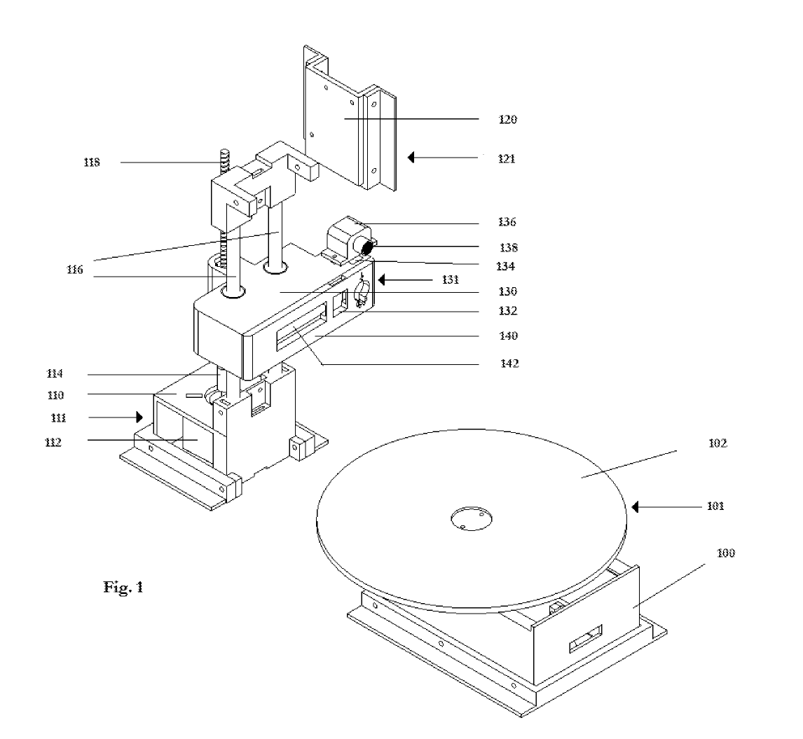

FIG. 1 shows a perspective view of one version of the apparatus. It comprises four main parts—the turntable assembly 101, the linear motor drive 111, the electronics processor 121 and the movable camera carriage 131. The whole apparatus may be enclosed in an enclosure as we'll discuss Isyrt.

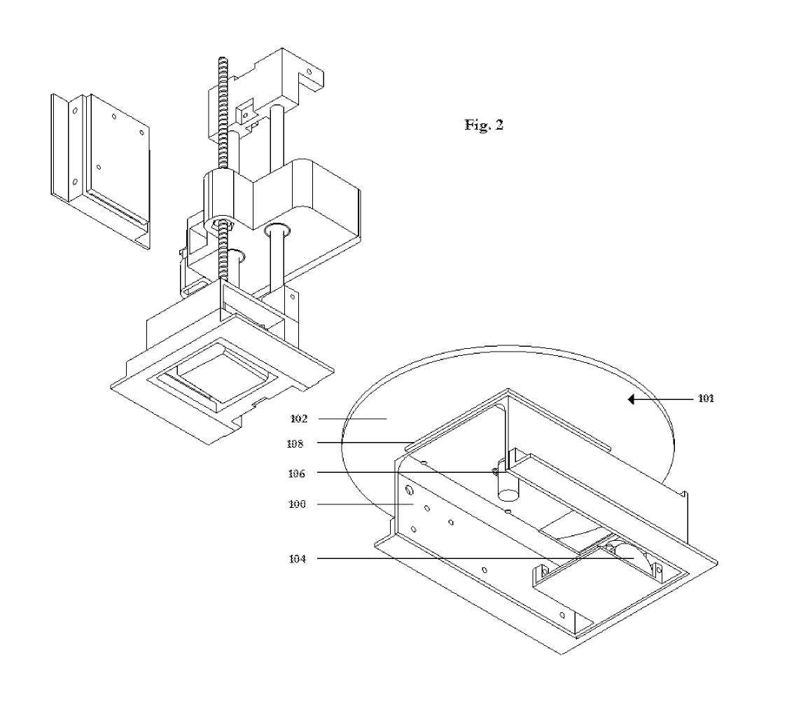

FIGS. 1 and 2 describe the turntable assembly 101. It is made of a base 100. The base is connected to the bottom side of a thrust bearing 108 using nuts and bolts. The top side of the thrust bearing is connected to a material cut in a circular shape 102 using nuts and bolts. A motor 106 is attached to the top side of the base 100 using nuts, and the shaft of the motor is attached to the circular shape 102 either directly by pushing and fitting, or through the use of a coupler that screws both parts together. The motor is connected to the electronics board 120 using electric wires. The bottom of the circular material 102 is coated with optical markers, used to encode its rotational position. In one low-cost embodiment, that marker is simply a sheet of paper with a binary Gray-coded disk. A camera or other optical sensor 104 sits on the bottom of the base and points towards the disk and captures the angular position of the table and sends it back to the electronics board 120.

The linear motor drive 111 is best described in FIG. 1. It comprises a base 110. A motor 112 is bolted onto to the base. A coupler 114 is attached to the motor's shaft. A threaded rod 118 is then attached to the other side of the coupler. Two smooth rods 116 are also push fitted into specially designed holes in the base. The motor 112 is connected to the electronics board 120. The purpose of the linear motor drive is to allow the assembly 131 to move up and down—in this embodiment, the threaded rod 118 is connected to the assembly 131 using hexagonal nuts and the smooth rods 116 are connected to the assembly 131 using push bearings. Rotating the motor causes the threaded rod to rotate, and hence the screws to advance up or down based on the motor direction. This in turn causes the assembly to slide in that direction.

The moveable camera carriage 131 is made of a housing 130 that is designed to hold a camera or other optical receptor, a laser or other optical emitter, and optionally, a white light. In this embodiment, a camera 142 is fitted inside the housing, pointing towards the turntable. The camera is connected to the electronics board 120. In additional a white LED light source 132 is placed near the camera and also connected to the electronics board. A servo motor 134 is push fitted onto a hole of the same size on the housing 130. The servo is connected to the electronics board using electric wires. A line laser 138 is placed inside a metallic laser holder 136. The metallic laser holder 136 is screwed onto the servo 134. The line laser 138 is connected to the electronic board 120 using electric wires. A cover 140 push-fits into the movable camera carriage and further ensures the camera and light remain stationary.

Finally, an electronics board 120 and holder control most of the above components. The board may be optionally connected to an external computer or laptop and respond to its commands, or it can independently perform commands.

### OPERATION

The scanner operation involves measuring the profile of the projected laser line onto the target object from various calculated orientations and positions.

To do so, a target is placed on the turntable. The electronics board directs the line laser to be turned on and the camera to start capturing images. A first image is captured, and the profile of the projected laser is detected and used to compute the geometry of the object along that plane since the laser and camera positions in the real world are known. The camera underneath the turntable returns angular the position of the turntable to the electronics board and this allows a single slice of the target model to be reconstructed. Once that is done, the electronics board asks the turntable to spin by the smallest amount that it can spin, and the process is repeated. By combining multiple slices a 3D model of the object is created.

The reconstructed model will typically have several missing parts because many objects cannot be captured with just a fixed camera, a laser and a turntable. At this point, the electronics controller or processor calculate where the missing parts are and ranks them by importance. From that information, it re-adjusts the laser direction by moving the servo, moves the turntable or moves the camera assembly up and down in order to capture a second view of the model that would fill the most holes. This is made possible since each of these systems has a known positional state that is tracked by the processor. The scanner is then re-activated as before. The new model is combined with the old model and the process is repeated. It may also choose to position the laser, camera or object in such a way as to confirm that previous points are valid and not due to noise. For example if a point is seen from two different positions it is more likely to be valid. Other factors come into account when the electronics controller is choosing which position to move the scanner to next: vertex density, meaning the number of measured points in a fixed volume, can be considered. This means that if the laser measured 10 points in a one cubic centimeter volume, but measured 10,000 points in the nearby cubic centimeters, that may be worth some further scanning to confirm. Inter-vertex displacement is another factor—namely if the vertex positions within a specific volume are very noisy and tend to jump a lot. An example formal definition could be: average distance from the vertex to its nearest 8 neighbors. If for some vertices the average distance is much more than the average distance across all vertices, it's possible this is an area of noise that needs to be further investigated.

With that method, the model is repeatedly refined.

For example, if scanning a tall object, the first scan would show that there is a hole at the top of the object since the upper points in real object were out of range of the camera and laser and were not captured. The scanner would respond by moving the camera and laser assembly upwards and performing a second scan.

Optionally, in a second step, the white light is activated and the laser turned off, and a second scan is performed in a manner similar to the first one. The white light allows for capture of color and texture information now that the geometry is known. Using the angular position of the turntable, the position of each of the faces and vertices of the model is estimated and the respective textures and faces are extracted from the image captured by the camera. This allows for a fully-colored and fully-textured model to be reconstructed.

When color is captured, it becomes easier for the system to adjust the measured data. To be more specific, if a captured vertex turns out to be of a darker color, then the threshold for considering it a valid vertex is lowered. This is because darker colors emit less light when a laser is shined upon them so that if a laser profile contained points that turned out to be dark then they are more likely to be correct. On the other hand if a point that turned out to be very light in color, or white, or the color of the laser, was caught in the laser profile, the threshold for considering it a valid point would have to be increased. This is because shining a bright laser onto a bright surface will cause a lot of light to be captured by the camera, even in nearby points. The idea behind this system is to use color information to decrease the noise by adjusting the probability of a point being valid based on its color.

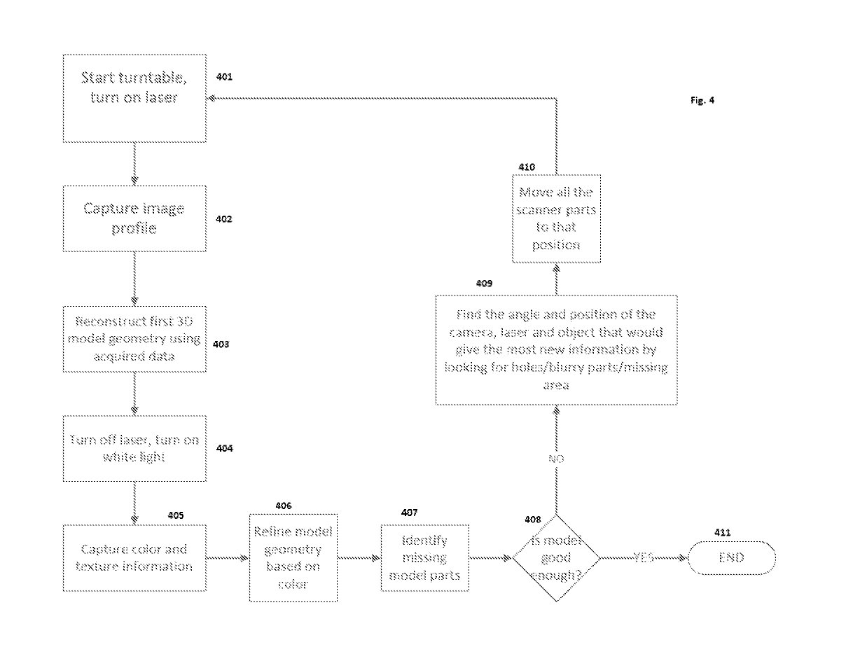

The entire functionality is simplified and summarized in FIG. 4, re-summarized here: the electronics controller starts the turntable and activates the light emitter, in this case a laser, in 401. While the object is spinning on the turntable, the profiles are being captured in 402. From those profiles, a first version of the model gets reconstructed in 403. Once the initial geometry has been acquired, the white light is turned on while the laser is turned off in 404. With the turntable still going, this allows for the capture of color and texture information 405, which as described above is used to refine the overall geometry in 406. The generated model is then scanned for holes and missing parts or areas where there are clearly fewer points than average in 407. If no such issues are found, the model is considered complete in 411, otherwise the optimal parameters for the camera, laser and other components are evaluated in 408 then the scanner moves to those positions in 409, repeating the process and further refining the acquired model.

The overall advantages of such an apparatus are that:
1—The components are low-cost as can be seen by the figure. Cameras, motors, lasers are generally inexpensive.
2—The scan is accurate as the turntable has positional feedback, the laser is thin and the camera assembly is based on an accurate threaded rod drive.
3—The scan is fast as the apparatus automatically detects where any holes are and directs the components to scan that area, instead of consistently wasting scan time by re-evaluating parts that it's already confident about.
4—The scan can be stopped at any time—every scan is simply a further refinement of the model and the quality tends to get better over time.
5—The scanner is able to mitigate any occlusions by repositioning the camera and laser assembly as appropriate.
6—The scan captures color and texture and is able to generate a fully colored model.

### ALTERNATIVE EMBODIMENTS

We believe there are several ways to implement the overall system described above. The common factors are an automatically movable optical receptor and light emitter, as well as a controller to decide where to move them next for optimal functionality.

One such embodiment involves mounting the camera assembly onto a mechanical arm that has positional feedback. Such an arm is typically made of one or more motors behaving as joints to the camera assembly. An example is shown in FIG. 4. In this case we have shown only two motor joints 302 and 304. Both of these motors are controlled by the electronics controller. They are screwed in to the arms represented by 306. The purpose of this configuration is to allow the camera and laser assembly to be positioned in a variety of positions with respect to the target object. The motors used for the joints have positional feedback information, such as that provided by a servo motor, which means that the position of the laser/camera assembly is known to the electronics component. In this scenario the electronics controller would select where to move the arm to capture the best amount of data. The scan would then proceed as in the first embodiment. This can also be done with an arm that has more degrees of freedom simply by adding more motors with different directions of axes.

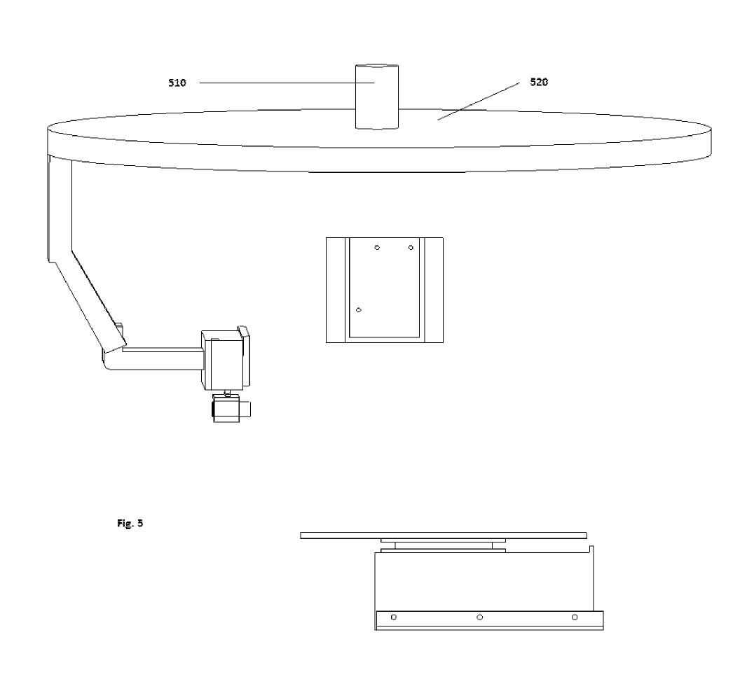

A third embodiment involves not having a turntable at all for the target object, and instead allowing the camera assembly to rotate around the object while being attached to an arm. This has the benefit of keeping the object stationary. FIG. 5 shows such an embodiment, where the camera arm is attached to a turntable 520 and controlled via a motor 510. There is also positional feedback system on the assembly turntable, similar in nature to the one before. In that case the object turntable is just a fixed staging area and no motors are connected there.

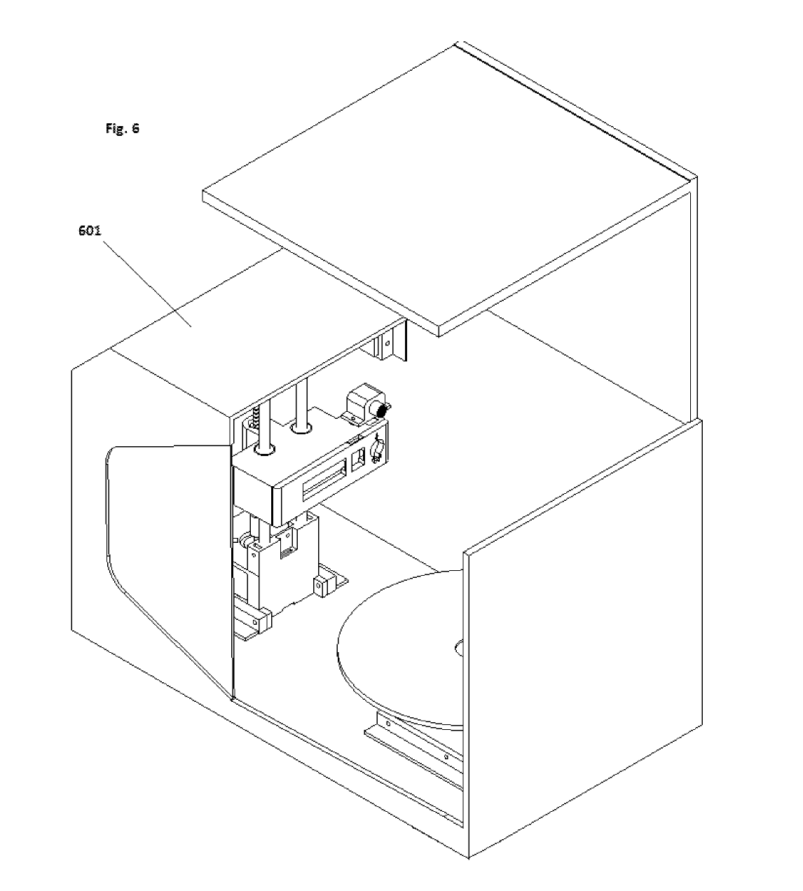

A fourth embodiment includes an enclosure around the device. Such an enclosure is shown in FIG. 6 as item 601. The purpose of that enclosure is to isolate external light from the internal light and vice-versa. Often 3D scanners are difficult to use when it is too bright outside, since light hitting the sensors might not be coming from the emitter but rather from the surroundings. Adding the enclosure makes sure that the light that is received by the sensor is the light that was emitted by the emitter. It also makes sure that none of the light emitted by the emitter finds its way outside of the device, possibly hitting the surrounding room. This can have an advantage when using lasers for example, as higher power lasers tend to give a bit more accuracy in certain cases but may be dangerous for human eyes. The enclosure allows the use of such lasers while minimizing any eye danger.

Other embodiments can be generated. For example:
a. Moving out the electronics board functionality directly into a computer, using the computer software directly to make any of the related decisions
b. Adding or removing degrees of freedom to the camera or laser motion, by adding joints, motors, or even having the camera and laser have separate independent motion systems, such as two three-jointed arms.
c. Using a light emitter other than a laser, such as a structured light projector.
d. Performing a few scans from random positions before deciding where to scan next

### CONCLUSIONS, RAMIFICATIONS AND SCOPE

Thus the reader will see that at least one embodiment of the 3D scanner provides a more reliable, inexpensive and efficient method for scanning, making such a 3D scanner more affordable to the general population without sacrificing quality.

While my above description contains many specificities, these should not be construed as limitations on the scope but rather as an exemplification of one or several embodiments thereof. Many other variations are possible. For example, it is possible to not have an enclosure with the system. It is possible for the electronics board to be outside of the system and implement instead on a computer for example. The linear drive, shown in the first embodiment as being based on a threaded rod can be based on a belt instead, or on a series of servo motors. The line laser can be replaced with multiple line lasers, or even point lasers.

Accordingly, the scope should be determined not by the embodiments illustrated, but by the appended claims and their legal equivalents.

I claim:

1. An apparatus for digitizing three dimensional objects comprising:
(a) a means of projecting light onto a target
(b) a means of moving said means of projecting light.
(c) a means of capturing said projected light
(d) a means of moving said means of capturing said projected light.

2. The apparatus of claim 1, further comprising a means of rotating an object along a fixed axis

3. The apparatus of claim 1, wherein the light projector emits a thin plane of light, and the light capture means is a digital camera.

4. The apparatus of claim 3, further comprising an enclosure surrounding said apparatus.

5. The apparatus of claim 1, wherein the means of moving the light projector comprises a linear drive.

6. The apparatus of claim 1, wherein the means of moving the light projector comprises a mechanical arm with one or more joints.

7. The apparatus of claim 1, further comprising a second means of projecting light of a different color than the first means of projecting light.

8. The apparatus of claim 1, further comprising a means of identifying the position of said light projector and of the light capturing means.

9. The apparatus of claim 2, where the means of rotating an object is a motor controlled turntable, and further comprising a means of detecting the position of the turntable.

10. The apparatus of claim 9, wherein the means of detecting the position of the turntable comprises a camera and a set of optical markers, said optical markers being attached to the bottom of the turntable, and said camera being oriented towards said optical markers.

11. The apparatus of claim 1, wherein the means of moving the light projector comprises a servo controlled motor, said servo controlled motor being attached to the light projector.

12. The apparatus of claim 1, wherein the means of moving the light projector comprises a stepper motor, said stepper motor being attached to the light projector.

13. The apparatus of claim 7, further comprising a second means of moving said second light projector.

14. The apparatus of claim 1, further comprising an electronic controller to control the various electronic parts.

15. A method for digitizing three-dimensional objects comprising:
(a) scanning a target object a first time with a narrow beam of a first colored light and generating its geometrical data via an electronic controller.
(b) scanning said target object a second time with a second colored light and extracting color information.
(c) using said color information to modify said geometrical data representation in said electronic controller.

16. A method for digitizing three-dimensional objects comprising:
(a) scanning a target object a first time with a scanner apparatus, obtaining said target object's initial geometry and returning it to an electronic processing means.
(b) said electronic processing means identifying areas of interest from said initial geometry.
(c) said electronic processing means selecting new positional parameters for the scanner apparatus components that would improve the quality of said initial geometry.
(d) said electronic processing means sending a signal to said scanner apparatus components to move them to said positional parameters.
e. Repeating steps (a)-(d) above until said electronic processing means determines that it should stop.

17. The method of claim 16 wherein the electronic processing means is a microprocessor present as part of the apparatus.

18. The method of claim 16 wherein the electronic processing means is a separate computer that communicates with the apparatus through electric wires.

19. The method of claim 16 wherein the said areas of interest comprise holes found in the initial geometry.

20. The method of claim 16 wherein the said areas of interest are areas in the geometry, that have a vertex density that is different than that of surrounding areas.

21. The method of claim 16 wherein the scanner comprises a light emitter and a light receiver.

22. The method of claim 21 wherein the light emitter emits a thin plane of light and the light receiver is a camera.

23. The method of claim 22 wherein the scanner further comprises a means to move said light emitter and receiver, relative to the target object.
